(19) United States
(12) Patent Application Publication
(10) Pub. No.: US 2014/0117009 A1
(43) Pub. Date: May 1, 2014

(54) MICROWAVE HEATING APPARATUS AND PROCESSING METHOD

(71) Applicant: Tokyo Electron Limited, Tokyo (JP)

(72) Inventor: Nobuhiko YAMAMOTO, Nirasaki City (JP)

(73) Assignee: Tokyo Electron Limited, Tokyo (JP)

(21) Appl. No.: 14/043,779

(22) Filed: Oct. 1, 2013

(30) Foreign Application Priority Data
Oct. 30, 2012 (JP) 2012-238795

(51) Int. Cl. H05B 6/64

(52) U.S. Cl. CPC H05B 6/6482; H05B 6/6491
USPC 219/759; 219/762

(57) ABSTRACT

A microwave heating apparatus includes, a processing chamber, a microwave introducing unit, a support member and a heat assist member. The processing chamber is configured to accommodate an object to be processed, the processing chamber having a top wall, a bottom wall and a sidewall. The microwave introducing unit is configured to generate a microwave for heating the object and introduce the microwave into the processing chamber. The support member is configured to support the object by contact with the object in the processing chamber. The heating assist member is configured to generate heat by absorbing the microwave and assist heating of the object by radiant heat, the heating assist member disposed to be separated from the object by the support member.

### CROSS-REFERENCE TO RELATED APPLICATIONS

This application claims priority to Japanese Patent Application No. 2012-238795 filed on Oct. 30, 2012, the entire contents of which are incorporated herein by reference.

### FIELD OF THE INVENTION

The present invention relates to a microwave heating apparatus for performing predetermined processing by introducing microwaves into a processing chamber and a processing method for heating an object to be processed by using the microwave heating apparatus.

### BACKGROUND OF THE INVENTION

In a semiconductor device manufacturing process, rapid heating referred to as RTA (Rapid Thermal Annealing) using a lamp heater as an apparatus for annealing a substrate such as a semiconductor wafer or the like has been used. However, recently, an apparatus using a microwave is suggested as an apparatus for annealing a substrate.

For example, Japanese Patent Application Publication No. 2000-150136 discloses a method for generating surface waves by irradiating microwaves to a dielectric member and allowing the surface waves to be absorbed by a microwave absorber opposite to a dielectric member via an air gap so that a heater can generate heat by heat transfer. Further, Japanese Patent Application Publication No. 2008-243965 discloses a method for heating a semiconductor substrate or a semiconductor film which has generated electron-hole pairs to 800° C. or above by irradiating a high frequency of about 1 MHz or above to the semiconductor substrate or the semiconductor film.

Japanese Patent Application Publication No. 2001-156049 discloses an organic material peeling apparatus including a rotatable supporting table for supporting a semiconductor wafer and an electromagnetic irradiation unit for heating the semiconductor wafer.

The microwave heating is advantageous in that the uniform heating can be performed because the microwaves are absorbed into the semiconductor wafer. On the other hand, it is disadvantageous in that the heating time is increased when the absorption rate of the microwaves into the semiconductor wafer is low.

### SUMMARY OF THE INVENTION

In view of the above, the present invention provides a microwave heating apparatus and a processing method capable of heating an object to be processed uniformly and efficiently.

In accordance with a first aspect of the present invention, there is provided a microwave heating apparatus including: a processing chamber configured to accommodate an object to be processed, the processing chamber having a top wall, a bottom wall and a sidewall; a microwave introducing unit configured to generate a microwave for heating the object and introduce the microwave into the processing chamber; a support member configured to support the object by contact with the object in the processing chamber; and a heating assist member configured to generate heat by absorbing the microwave and assist heating of the object by radiant heat, the heating assist member disposed to be separated from the object by the support member.

In accordance with a second aspect of the present invention, there is provided a processing method for heating an object to be processed by using a microwave heating apparatus including: a processing chamber configured to accommodate therein the object, the processing chamber having an upper wall, a bottom wall, and a sidewall; a microwave introducing unit configured to generate a microwave for heating the object and introduce the microwave into the processing chamber; a plurality of supporting members configured to support the object by contact with the object in the processing chamber; and a heating assist member configured to generate heat by absorbing the microwave and assist heating of the object by radiant heat, the heating assist member disposed to be separated from the object supported by the supporting members.

In the microwave heating apparatus and the processing method of the present invention, it is possible to heat the object uniformly and efficiently.

### BRIEF DESCRIPTION OF THE DRAWINGS

FIG. 1 is a cross sectional view showing a schematic configuration of a microwave heating apparatus in accordance with a first embodiment of the present invention;

FIG. 2 is a perspective view showing a dielectric plate attached with support pins in the first embodiment of the present invention;

FIG. 3 explains height positions of the dielectric plate and the support pins in the first embodiment of the present invention;

FIG. 4 explains a schematic configuration of a high voltage power supply unit of a microwave introducing unit in the first embodiment of the present invention;

FIG. 5 is a top view showing a top surface of a ceiling portion of a processing chamber shown in FIG. 1;

FIG. 6 explains a configuration of a control unit shown in FIG. 1;

FIG. 7 shows a model of temperature variation of a dielectric loss or a dielectric rate of a dielectric material that may be used in the first embodiment;

FIG. 8 is a cross sectional view showing a schematic configuration of a microwave heating apparatus in accordance with a second embodiment of the present invention;

FIG. 9 is a perspective view showing support pins and a dielectric plate in the second embodiment of the present invention;

FIG. 10 is a principal view for explaining an operation of the microwave heating apparatus of the second embodiment;

FIG. 11 is a graph showing a measurement result of a temperature increase rate of a wafer in test examples 1 and 2 and a comparative example;

FIG. 12 is a graph showing a measurement result of a temperature change of a volume resistance of an SiC plate used in the test examples 1 and 2; and

FIG. 13 is a graph showing a measurement result of a highest attainable temperature of a wafer in the case of varying a height of the SiC plate used in the test example 1.

### DETAILED DESCRIPTION OF THE EMBODIMENTS

Hereinafter, embodiments of the present invention will be described with reference to the accompanying drawings.

### First Embodiment

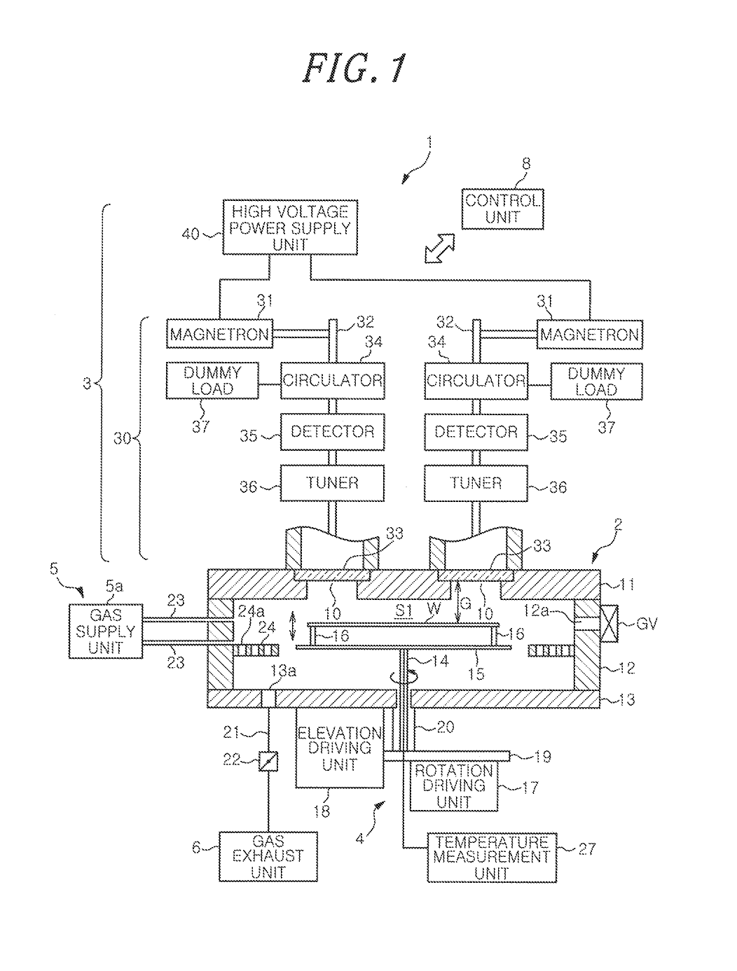

First, a schematic configuration of a microwave heating apparatus in accordance with a first embodiment of the present invention will be described with reference to FIG. 1. FIG. 1 is a cross sectional view showing a schematic configuration of a microwave heating apparatus of the present embodiment. A microwave heating apparatus 1 of the present embodiment is an apparatus for performing annealing by irradiating microwaves to, e.g., a semiconductor wafer (hereinafter, simply referred to as “wafer”) for manufacturing a semiconductor device in accordance with a plurality of consecutive operations. Here, a semiconductor material forming a semiconductor wafer may include a compound such as gallium nitride or the like, other than silicon.

The microwave heating apparatus 1 includes a processing chamber 2 for accommodating a wafer W as an object to be processed, a microwave introducing unit 3 for introducing microwaves into the processing chamber 2, a support unit 4 for supporting the wafer W, a gas supply mechanism for supplying a gas into the processing chamber 2, a gas exhaust unit 6 for exhausting the inside of the processing chamber 2, and a control unit 8 for controlling the respective components of the microwave heating apparatus

1.

<Processing Chamber>

The processing chamber 2 is made of a metallic material. As for the material of the processing chamber 2, aluminum, aluminum alloy, stainless steel or the like is used, for example.

The processing chamber 2 includes a plate-shaped ceiling portion 11 serving as a top wall, a bottom portion 13 serving as a bottom wall, an angular tube shaped sidewall 12 for connecting the ceiling portion 11 and the bottom portion 13, a plurality of microwave inlet ports 10 vertically extending through the ceiling portion 11, a loading/unloading port 12a provided at the sidewall 12, and a gas exhaust port 13a provided at the bottom portion 13. Further, the sidewall 12 may be formed in a cylindrical shape. Through the loading/unloading port 12a, the wafer W is transferred between the processing chamber 2 and a transfer chamber adjacent thereto (not shown). A gate valve GV is provided between the processing chamber 2 and the transfer chamber (not shown). The gate valve GV has a function of opening/closing the loading/unloading port 12a. The gate valve GV in a closed state airtightly seals the processing chamber 2, and the gate valve GV in an open state allows the wafer W to be transferred between the processing chamber 2 and the transfer chamber (not shown).

<Microwave Introducing Unit>

The microwave introducing unit 3 is provided above the processing chamber 2, and serves as a microwave introducing mechanism for introducing electromagnetic waves (microwaves) into the processing chamber 2. The configuration of the microwave introducing unit 3 will be described in detail later.

<Support Unit>

The support unit 4 includes: a pipe-shaped shaft 14 extending to the outside of the processing chamber 2 while penetrating through an approximate center of the bottom portion 13 of the processing chamber 2; a dielectric plate serving as a heating assist member provided near the upper end of the shaft 14 in an approximately horizontal direction; and a plurality of support pins 16 serving as support members that are detachably attached to the peripheral portion of the dielectric plate 15. The support unit 4 further includes a rotation driving unit 17 for rotating the shaft 14, an elevation unit 18 for vertically displacing the shaft 14, and a movable connection unit 19 for connecting the rotation driving unit 17 and the elevation driving unit 18 while supporting the shaft 14. The rotation driving unit 17, the elevation driving unit 18 and the movable connection unit 19 are provided outside the processing chamber 2. A seal mechanism 20, e.g., a bellows or the like, may be provided around a portion where the shaft 14 penetrates through the bottom portion 13 in order to set the inside of the processing chamber 2 in a vacuum state.

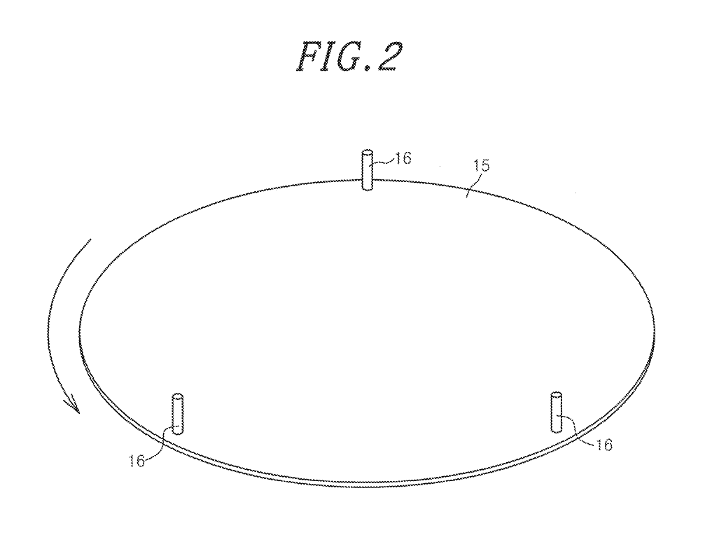

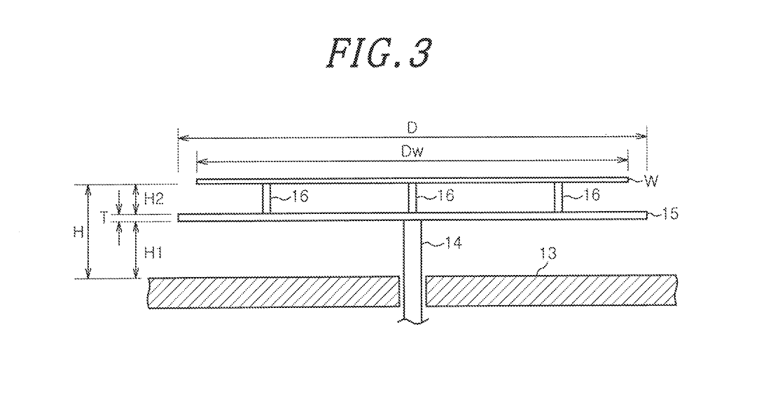

FIG. 2 is a perspective view showing the dielectric plate 15 attached with the support pins 16. FIG. 3 is an explanatory view showing a dielectric plate 15, support pins 16, and a height position of the wafer W supported on the support pins 16 which are seen from the side. A plurality of (three in the present embodiment) support pins 16 support the wafer W while being in contact with the bottom surface of the wafer W in the processing chamber 2. The upper end portions of the support pins 16 are arranged along the circumferential direction of the wafer W. The support pins 16 are detachably attached to the dielectric plate 15.

The dielectric plate 15 has a heating assist function. Here, [symbol] heating assist function [symbol] indicates that the dielectric plate 15 generates heat by absorbing microwaves and the heating of the wafer W is facilitated by the radiant heat. As for the dielectric material forming the dielectric plate 15, it is possible to use, a material that hardly causes contamination or the like, e.g., silicon carbide (SiC), silicon nitride (SiN), aluminum oxide (Al₂O₃), aluminum nitride (AlN) or the like may be used in view of ensuring reliability of a semiconductor process.

In order to obtain a sufficient heating assist function at a relatively low temperature range in a temperature increasing process, a dielectric material whose microwave absorption rate is decreased and whose reflectivity is increased, as a temperature is increased is preferably used for the dielectric plate 15. The peak of the dielectric rate or the dielectric loss exists at a temperature range up to, e.g., about 400° C. At a temperature range higher than 400° C., it is preferable to use a material having a high conductive property due to a relatively low dielectric rate or dielectric loss. In view of the above, the dielectric material of the dielectric plate 15 preferably has a semiconductive property. For example, it is preferable to use a material having an energy band gap ranging from about 2 eV to 9 eV. Such a dielectric material includes, e.g., SiC, GaN, GaAs, C, SiN, Al₂O₃ and the like. More preferably, it is preferable to use a material having an energy band gap ranging from about 2 eV to 6 eV. Such a dielectric material includes, e.g., SiC, GaN, GaAs, C and the like.

The support pins 16 are made of a dielectric material. As for the dielectric material of the support pins 16, it is possible to use, e.g., quartz, ceramic or the like.

In the present embodiment, the dielectric plate 15 is disposed between the wafer W and the bottom portion 13 while being separated from the wafer W below the wafer W. The dielectric plate 15 has, as main surfaces having a largest area, a top surface and a bottom surface. The wafer W has, as main surfaces having a largest area, a top surface and a bottom surface. The bottom surface of the wafer W and the top surface of the dielectric plate 15 are arranged such that at least partial portions thereof face each other. Preferably, the entire bottom surface of the wafer W is arranged to as to face the top surface of the dielectric plate 15.

In the present embodiment, the dielectric plate 15 is one of the components of the support unit 4 for supporting the wafer W and serves as a heating assist unit for assisting heating of the wafer W. For example, in order to make the dielectric plate 15 effectively function as the heating assist unit in a process of increasing a temperature of the wafer W to about 400° C., it is preferable to separate the dielectric plate 15 from the bottom portion 13. In that case, a height H1 from the top surface of the bottom portion 13 to the bottom surface of the dielectric plate 15 may be set within a range from, e.g., about 3 mm to 40 mm and preferably within a range from about 30 mm to 40 mm. Further, when it is required to reduce absorption of the microwaves by the dielectric plate 15 at a temperature higher than, e.g., 400° C., it is preferable to lower the dielectric plate 15 by a large distance and bring the dielectric plate 15 into contact with the bottom wall 13 of the ground potential, for example (height H1=0).

The support pins 16 has a protrusion height that allows the wafer W to be separated from the dielectric plate 15 by a predetermined gap. The protrusion height of the support pins 16 is the same as a height H2 from the top surface of the dielectric plate 15 to the bottom surface of the wafer W which is shown in FIG. 3. The height H2 may be within a range from about 3 mm to 40 mm, and preferably within a range from about 10 mm to 30 mm, in order to make the dielectric plate 15 effectively function as a heating assist unit. In the present embodiment, the height H2 may be adjusted by replacing the support pins 16. Further, the number of the support pins 16 is not limited to three as long as the wafer W can be stably supported.

In the present embodiment, the wafer W and the dielectric plate 15 each have a circular plate shape. A diameter D of the dielectric plate 15 is preferably greater than at least a diameter DW of the wafer W. Moreover, the dielectric plate 15 may have any shape, e.g., a block shape or the like, as long as it has a function of assisting the heating of the wafer W. A thickness T of the dielectric plate 15 affects the heating assist effect to the wafer W. In order to make the dielectric plate 15 effectively function as a heating assist unit, the thickness T is preferably selected within a range from, e.g., about 2 mm to mm, in consideration of the height H1 from the top surface of the bottom portion 13 to the bottom surface of the dielectric plate 15, and the height H2 from the top surface of the dielectric plate 15 to the bottom surface of the wafer W.

In the support unit 4, the shaft 14, the dielectric plate 15, the rotation driving unit 17 and the movable connection unit 19 constitute a rotation mechanism for horizontally rotating the wafer W supported by the support pins 16. The support pins 16 and the dielectric plate 15 are rotated about the shaft 14 as the rotation center by driving the rotation driving unit 17, and each of the support pins 16 is rotated horizontally in circular motion (revolved). Further, in the support unit 4, the shaft 14, the elevation driving unit 18 and the movable connection unit 19 constitute a height adjusting mechanism for adjusting a height of the wafer W supported by the support pins 16 and the dielectric plate 15. The dielectric plate 15 and the support pins 16 are configured to be vertically displaced together with the shaft 14 by driving the elevation driving unit 18.

The rotation driving unit 17 is not particularly limited as long as it can rotate the shaft 14, and may have, e.g., a motor (not shown) or the like. The elevation driving unit 18 is not particularly limited as long as it can vertically displace the shaft 14 and the movable connection unit 19, and may have, e.g., a ball screw (not shown) or the like. The rotation driving unit 17 and the elevation driving unit 18 may be formed as one unit, or the movable connection unit 19 may not be provided. Further, the rotation unit for horizontally rotating the wafer W and the height adjusting unit for adjusting the height of the wafer W may have other configurations as long as the purpose thereof can be realized.

(Gas Exhaust Unit)

The gas exhaust unit 6 includes a vacuum pump, e.g., a dry pump or the like. The microwave heating apparatus 1 includes a gas exhaust line 21 for connecting a gas exhaust port 13a and the gas exhaust unit 6, and a pressure control valve 22 disposed on the gas exhaust line 21. By driving the vacuum pump of the gas exhaust unit 6, the inside of the processing chamber 2 is vacuum-exhausted. Further, the microwave heating apparatus 1 can perform processing under an atmospheric pressure. In that case, the vacuum pump is not necessary. Instead of using the vacuum pump such as a dry pump or the like as the gas exhaust unit 6, it is possible to use gas exhaust equipment provided at a facility where the microwave heating apparatus 1 is installed.

(Gas Supply Mechanism)

The microwave heating apparatus 1 further includes a gas supply mechanism 5 for supplying a gas into the processing chamber 2. The gas supply mechanism 5 includes: a gas supply unit 5a having a gas supply source (not shown); and a plurality of lines 23, connected to the gas supply unit 5a, for introducing a processing gas into the processing chamber 2. The lines 23 are connected to the sidewall 12 of the processing chamber 2.

The gas supply unit 5a is configured to supply a gas, e.g., N₂, Ar, He, Ne, O₂, H₂ or the like, as a processing gas or a cooling gas, into the processing chamber 2 via the line 23 in a side flow type. The gas supply into the processing chamber 2 may be performed by a gas supply device provided at, e.g., a position corresponding to the wafer W (e.g., the ceiling portion 11). An external gas supply unit that is not included in the configuration of the microwave heating apparatus 1 may be used instead of the gas supply unit 5a. Although it is not illustrated, the microwave heating apparatus 1 includes mass flow controllers and opening/closing valves which are disposed on the lines 23. The types of gases supplied into the processing chamber 2 or the flow rates of the gases are controlled by the mass flow controller and the opening/closing valve.

(Rectifying Plate)

The microwave heating apparatus 1 includes a frame-shaped rectifying plate 24 disposed between the sidewall 12 and the periphery of the support pins 16 in the processing chamber. The rectifying plate 24 has a plurality of rectifying holes 24a penetrating through the rectifying plate 24 in a vertical direction. The rectifying plate 24 rectifies an atmosphere of the region where the wafer W will be placed while allowing the gas in the region to flow toward the gas exhaust port 13a. The rectifying plate 24 is made of a metallic material, e.g., aluminum, aluminum alloy, stainless steel or the like. Further, the rectifying plate 24 is not essential for the microwave heating apparatus 1 and thus may not be provided.

(Temperature Measurement Unit)

The microwave heating apparatus 1 further includes a plurality of radiation thermometers (not shown) for measuring a surface temperature of the wafer W, and a temperature measurement unit 27 connected to the radiation thermometers.

(Microwave Radiation Space)

In the microwave heating apparatus 1 of the present embodiment, the space defined by the ceiling portion 11, the sidewall 12 and the rectifying plate 24 in the processing chamber 2 forms a microwave radiation space S1.

In the microwave radiation space S1, microwaves are radiated from a plurality of microwave inlet ports 10 provided at the ceiling portion 11. Since the ceiling portion 11, the sidewall 12 and the rectifying plate 24 of the processing chamber 2 are made of a metallic material, the microwaves are reflected and scattered in the microwave radiation space S1.

(Microwave Introducing Unit)

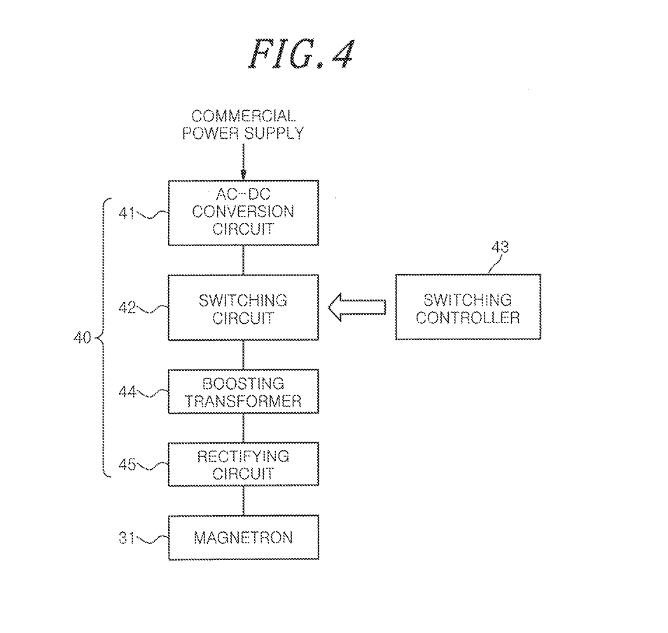

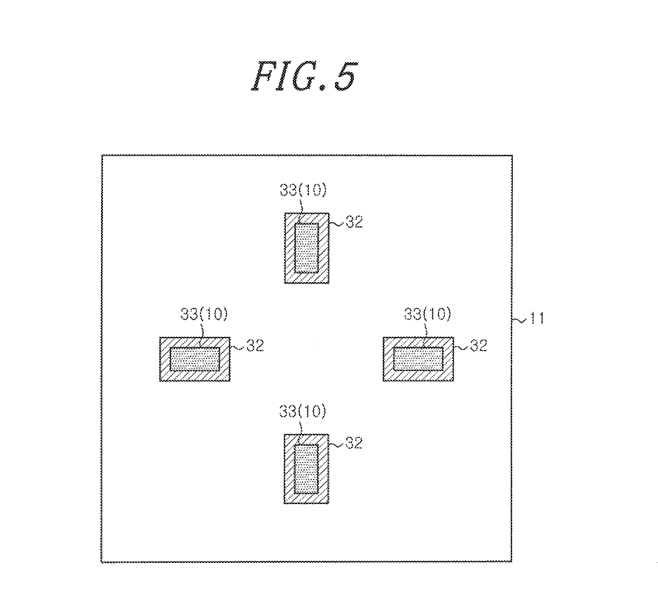

The configuration of the microwave introducing unit 3 will be described with reference to FIGS. 1, 4 and 5. FIG. 4 is an explanatory view showing a schematic diagram of a high voltage power supply unit of the microwave introducing unit 3. FIG. 5 is a top view showing the top surface of the ceiling portion 11 of the processing chamber 2 shown in FIG. 1.

As described above, the microwave introducing unit 3 serves as a microwave introducing mechanism for introducing electromagnetic waves (microwaves) into the processing chamber 2, and is provided at an upper portion of the processing chamber 2. As shown in FIG. 1, the microwave introducing unit 3 includes a plurality of microwave units 30 for introducing microwaves into the processing chamber 2, and a high voltage power supply unit 40 connected to the microwave units 30.

(Microwave Unit)

In the present embodiment, the microwave units 30 have the same configuration. Each of the microwave units 30 includes a magnetron 31 for generating microwaves for processing the wafer W, a waveguide 32 for transmitting the microwaves generated by the magnetron 31 to the processing chamber 2, and a transmission window 33 fixed to the ceiling portion 11 so as to block the microwave inlet ports 10. The magnetron 31 corresponds to a microwave source of the present invention.

As shown in FIG. 5, in the present embodiment, the processing chamber 2 has four microwave inlet ports 10 that are spaced apart from each other at a regular interval in a circumferential direction so as to form an approximately cross shape at the ceiling portion 11. Each of the microwave inlet ports 10 has a rectangular shape with short sides and long sides in a plan view. The microwave inlet ports 10 may have different sizes or different ratios between the long sides and the short sides. However, the four microwave inlet port 10 preferably have the same size and the same shape in order to enhance uniformity of the annealing process for the wafer W and improve controllability. In the present embodiment, the microwave units 30 are connected to the microwave inlet ports 10, respectively. In other words, the number of the microwave units 30 is four.

The magnetron 31 has an anode and a cathode (all not shown) to which a high voltage supplied by the high voltage power supply unit 40 is applied. As for the magnetron 31, it is possible to use one capable of oscillating microwaves of various frequencies. The frequency of the microwaves generated by the magnetron 31 is properly selected in accordance with types of processing for the object. For example, in case of an annealing process, the microwaves having a high frequency of about 2.45 GHz, 5.8 GHz or the like are preferably used, and the microwaves having a high frequency of about 5.8 GHz are more preferably used.

The waveguide 32 has a rectangular or angular tube shaped, and extends upward from the top surface of the ceiling portion 11 of the processing chamber 2. The magnetrons 31 are connected to the upper end portions of the waveguides 32. The lower end portions of the waveguides 32 contact with the top surface of the transmission window 33. The microwaves generated by the magnetron 31 are introduced into the processing chamber 2 through the waveguides 32 and the transmission window 33.

The transmission window 33 is made of a dielectric material. As for the material of the transmission window 33, it is possible to use, e.g., quartz, ceramic or the like. The space between the transmission window 33 and the ceiling portion 11 is airtightly sealed by a seal member (not shown). A distance (gap G) from the bottom surface of the transmission window 33 to the top surface of the wafer W supported by the support pins 16 is preferably, e.g., about 25 mm or above, in view of reducing direct radiation of microwaves to the wafer W. More preferably, it is variably controlled within a range from about 25 mm to 50 mm.

The microwave unit 30 includes a circulator 34, a detector 35 and a tuner 36 which are disposed on the waveguide 32, and a dummy load 37 connected to the circulator 34. The circulator 34, the detector 35 and the tuner 36 are provided in that order from the upper end side of the waveguide 32. The circulator 34 and the dummy load 37 constitute an isolator for isolating reflected waves from the processing chamber 2. In other words, the circulator 34 guides the reflected waves from the processing chamber 2 to the dummy load 37, and the dummy load 37 converts the reflected waves guided by the circulator 34 into heat.

The detector 35 detects the reflected waves from the processing chamber 2 in the waveguide 32. The detector 35 is, e.g., an impedance monitor. Specifically, it is formed by a standing wave monitor for detecting an electric field of a standing wave in the waveguide 32. The standing wave monitor can be formed by, e.g., three pins projecting into the inner space of the waveguide 32. The reflected wave from the processing chamber 2 can be detected by detecting the location, phase and intensity of the electric field of the standing wave by using the standing wave monitor. Further, the detector 35 may be formed by a directional coupler capable of detecting a traveling wave and a reflected wave.

The tuner 36 performs impedance matching between the magnetron 31 and the processing chamber 2. The impedance matching by the tuner 36 is performed based on the detection result of the reflected wave in the detector 35. The tuner 36 may be, e.g., a conductive plate (not shown) that can be inserted into and retreated from the inner space of the waveguide 32. In that case, the impedance between the magnetron 31 and the processing chamber 2 can be controlled by adjusting the power of the reflected wave by controlling the projecting amount of the conductive plate into the inner space of the waveguide 32.

(High Voltage Power Supply Unit)

The high voltage power supply unit 40 supplies a high voltage to the magnetron 31 for generating a microwave. As shown in FIG. 4, the high voltage power supply unit 40 includes an AC-DC conversion circuit 41 connected to a commercial power supply, a switching circuit 42 connected to the AC-DC conversion circuit 41, a switching controller 43 for controlling an operation of the switching circuit 42, a boosting transformer 44 connected to the switching circuit 42, and a rectifying circuit 45 connected to the boosting transformer 44. The magnetron 31 is connected to the boosting transformer 44 via the rectifying circuit 45.

The AC-DC conversion circuit 41 rectifies an alternating current (e.g., three phase 200V AC) supplied from the commercial power supply and converting it to a direct current having a predetermined waveform. The switching circuit 42 controls on/off of the direct current converted by the AC-DC conversion circuit 41. In the switching circuit 42, the switching controller 43 performs phase-shift PWM (Pulse Width Modulation) control or PAM (Pulse Amplitude Modulation) control, thereby generating a pulsed voltage waveform. The boosting transformer 44 boosts the voltage waveform outputted from the switching circuit 42 to a predetermined level. The rectifying circuit 45 rectifies the voltage boosted by the boosting transformer 44 and supplies the rectified voltage to the magnetron 31.

(Control Unit)

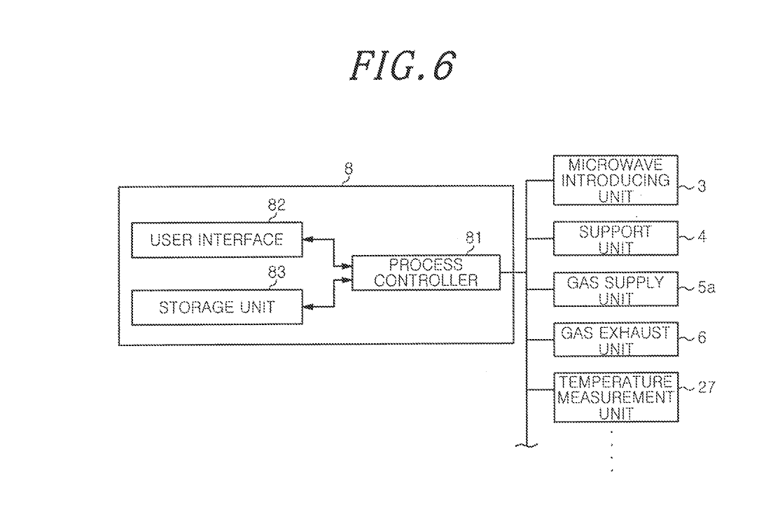

Each component of the microwave heating apparatus 1 is connected to and controlled by the control unit 8. The control unit 8 is typically a computer. FIG. 6 is an explanatory view showing the configuration of the control unit 8 shown in FIG. 1. In the example shown in FIG. 6, the control unit 8 includes a process controller 81 having a CPU, a user interface 82 and a storage unit 83 connected to the process controller 81.

The process controller 81 integrally controls the components of the microwave processing apparatus 1 (e.g., the microwave introducing unit 3, the support unit 4, the gas supply unit 5a, the gas exhaust unit 6, the temperature measurement unit 27 and the like) which relate to the processing conditions such as a temperature, a pressure, a gas flow rate, an output of a microwave, a rotation speed of the wafer W and the like.

The user interface 82 includes a keyboard or a touch panel through which a process manager inputs commands to manage the microwave processing apparatus 1, a display for displaying an operation status of the microwave processing apparatus 1, or the like.

The storage unit 83 stores therein control programs (software) for implementing various processes performed by the microwave processing apparatus 1 under the control of the process controller 81, and recipes in which processing condition data and the like are recorded. The process controller 81 executes a certain control program or recipe retrieved from the storage unit 83 in response to an instruction from the user interface 82 when necessary. Accordingly, a desired process is performed in the processing chamber 2 of the microwave processing apparatus 1 under the control of the process controller 81.

The control programs and the recipes may be stored in a computer-readable storage medium, e.g., a CD-ROM, a hard disk, a flexible disk, a flash memory, a DVD, a Blu-ray disc, or the like. Further, the recipes may be transmitted online from other devices via, e.g., a dedicated line, whenever necessary.

(Operation of the First Embodiment)

Hereinafter, the effects of the microwave processing apparatus 1 in accordance with the present embodiment will be described. The power P of the microwave absorbed by the dielectric plate 15 can be calculated by the following equation. In the equation, f indicates a frequency [Hz] of the microwave; v indicates an electric field intensity [V/m] of the microwave; ∈ indicates a relative dielectric constant of a material of the dielectric plate 15; and tan δ indicates a dielectric tangent (δ being a dielectric loss angle) of the material of the dielectric plate 15. The following equation shows that the microwave absorption efficiency to the dielectric plate 15 is increased and the heating assist effect by the heat generation of the dielectric plate 15 is increased by using a material having a high relative dielectric constant and a large dielectric loss angle.

$$P [ \frac{W}{{m}^{3}} ] = \text{?} {fv}^{2} \text{?} tan δ \text{?} \\ \text{?} \text{indicates text missing or illegible when filed} \qquad ( Eq . 1 )$$

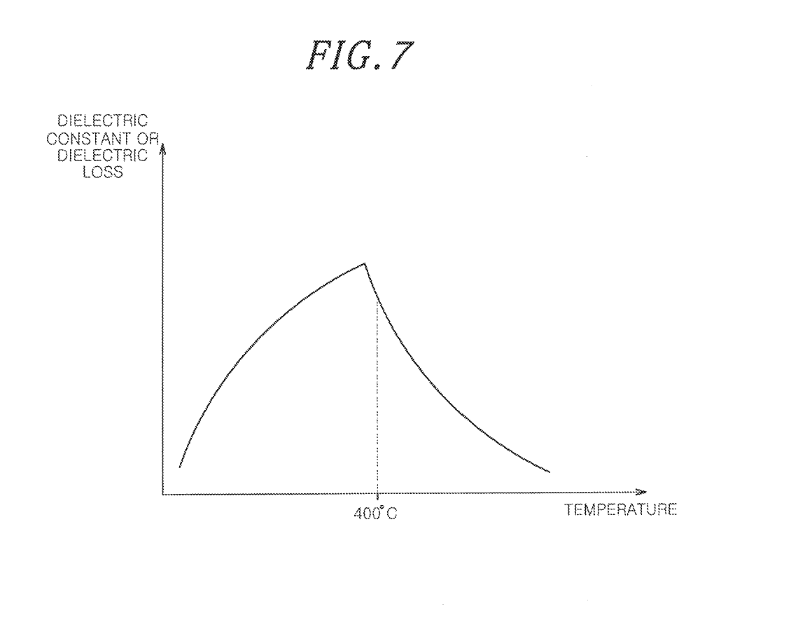

In the present embodiment, as for a dielectric material of the dielectric plate 15, it is preferable to use a dielectric material whose microwave absorption rate is decreased and reflectivity is relatively increased as the temperature is increased. FIG. 7 shows a model of temperature variation of a dielectric constant or a dielectric loss of a dielectric material that is usable in the present invention. As shown in FIG. 7, the peak of the dielectric rate or the dielectric loss exists at a temperature range up to, e.g., about 400° C. At a temperature range higher than 400° C., it is possible to use a material having a high conductive property due to a relatively low dielectric rate or dielectric loss. The dielectric material having properties shown in FIG. 7 can generate heat by effectively absorbing microwaves in a temperature increasing process of about 400° C. or less and assist the heating of the wafer W by radiant heat. Further, in a process of increasing a temperature to a level higher than about 400° C., the conductive property is enhanced and, thus, it is possible to reflect the microwave and reduce the loss of the microwave by the dielectric material. Therefore, in the microwave heating apparatus 1 of the present embodiment, it is possible to improve the heating efficiency of the wafer W, increase the heating rate, and improve a throughput of the annealing process by using the dielectric member 15. Moreover, in a range higher than about 400° C. as the processing temperature of the wafer W, the absorption of the power of the supplied microwave to the dielectric member 15 is relatively decreased and, thus, the power of the microwave can be effectively supplied to the wafer W.

In addition, in the present embodiment, the annealing process is performed while horizontally rotating the wafer W supported by the support pins 16 at a predetermined speed. Accordingly, the radiation of the microwave in the circumferential direction becomes uniform in the surface of the wafer W. As a result, the uniformity of the annealing process in the circumferential direction in the surface of the wafer W can be realized by the rotation.

[Processing Sequence]

Hereinafter, the sequence of processes performed in the microwave heating apparatus 1 in the case of performing an annealing process on a wafer W will be described. First, for example, a command is input from the user interface 82 to the process controller 81 so that the annealing process can be performed by the microwave processing apparatus 1. Next, the process controller 81 receives the command and retrieves a recipe stored in the storage unit 83 or a computer-readable storage medium. Then, the process controller 81 transmits control signals to the end devices of the microwave processing apparatus 1 (e.g., the microwave introducing unit 3, the support unit 4, the gas supply unit 5a, the gas exhaust unit 6 and the like) so that the annealing process can be performed under the conditions based on the recipe.

Thereafter, the gate valve GV is opened, and the wafer

W is loaded into the processing chamber 2 through the gate valve G and the loading/unloading port 12a by a transfer unit (not shown). The wafer W is mounted on the support pins 16. The support pins 16 are vertically moved together with the shaft 14 and the dielectric plate 15 by driving the elevation driving unit 18, and the wafer W is set in a predetermined height H. The height H may be set in consideration of the height H1, the thickness T and the height H2. By driving the rotation driving unit 17 at this height H, the wafer W is horizontally rotated at a predetermined speed. Further, the rotation of the wafer W may be non-consecutive. Next, the gate valve G is closed, and the processing chamber 2 is vacuum-evacuated by the gas exhaust unit 6 when necessary. Then, the predetermined amount of the processing gas is introduced into the processing chamber 2 by the gas supply unit 5a. The inner space of the processing chamber 2 is controlled at a specific pressure by controlling the gas exhaust amount and the gas supply amount.

Next, a microwave is generated by applying a voltage from the high voltage power supply unit 40 to the magnetron 31. The microwave generated by the magnetron 31 passes through the waveguide 32 and the transmission window 33 and then is introduced into the space above the wafer W in the processing chamber 2. In this embodiment, the microwaves are sequentially generated by the magnetrons 31 and introduced into the processing chamber 2 through the microwave inlet ports 10. Further, the microwaves may be generated at the same time by the magnetrons 31 and introduced into the processing chamber 2 from the microwave inlet ports 10 at the same time.

The microwaves introduced into the processing chamber 2 are irradiated to the rotating wafer W, so that the wafer W is rapidly heated by electromagnetic wave heating such as joule heating, magnetic heating, induction heating or the like. As a result, the wafer W is annealed. By rotating the wafer W during the annealing by the support unit 4, the deviation of the microwave irradiated to the wafer W can be decreased to make the heating temperature uniform in the surface of the wafer W. Moreover, the dielectric plate 15 provided near the wafer W generates heat by absorbing the microwave and thus can serve as the heating assist unit for facilitating heating of the wafer W by radiant heat. As a result, the heating of the wafer W is facilitated particularly at a low-temperature range of the temperature increasing process, thereby improving the heating rate. In the present embodiment, the height H of the wafer W and the height H1 of the dielectric plate 15 may be varied during the annealing process.

When the process controller 81 transmits a control signal to each end device of the microwave processing apparatus 1 to complete the anneal process, the generation of the microwave stopped and, also, the rotation of the wafer W and the supply of the processing gas and the cooling gas a stopped. Thus, the annealing process for the wafer W is completed. Thereafter, the gate valve GV opened, and the height of the wafer W on the support pins 16 is adjusted and the wafer W is unloaded by a transfer unit (not shown).

The microwave heating apparatus 1 may be suitable for an annealing process for activating doping atoms injected into the diffusion layer in a semiconductor device manufacturing process, for example.

In the microwave heating apparatus 1 and the processing method of the present embodiment, the dielectric plate 15 as the heating assist member is separated from the wafer W by a predetermined gap. Accordingly, the heating of the wafer W is facilitated, and the heating efficiency can be improved. In addition, since the annealing is performed while horizontally rotating the wafer W at a predetermined speed, the absorption of the microwave in the surface of the wafer W becomes uniform. Therefore, in accordance with the microwave heating apparatus and the processing method of the present embodiment, the annealing process can be effectively performed on the wafer W while ensuring excellent uniformity in the surface of the wafer W.

### Second Embodiment

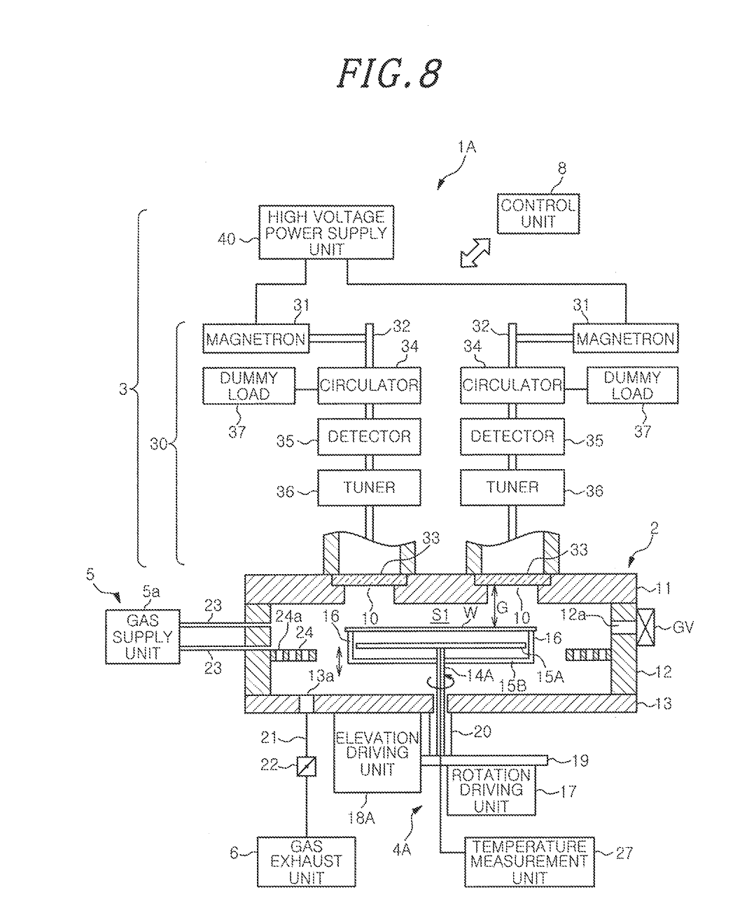

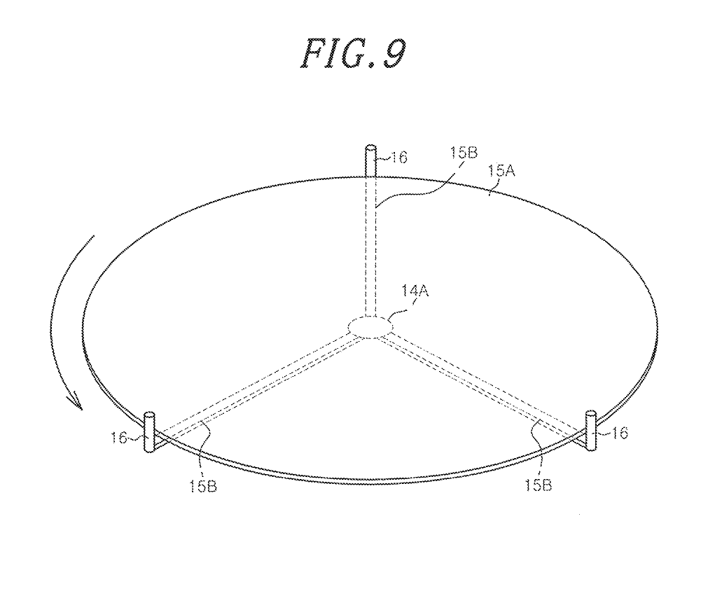

Hereinafter, a microwave heating apparatus in accordance with a second embodiment of the present invention will be described with reference to FIGS. 8 and 9. FIG. 8 is a cross sectional view showing a schematic configuration of a microwave heating apparatus 1A of the present embodiment. FIG. 9 is a perspective view showing a relationship between the support pins 16 and the dielectric plate 15A. The microwave heating apparatus 1A of the present embodiment is an apparatus for performing annealing by irradiating a microwave on, e.g., a wafer W, in accordance with a plurality of consecutive processed. In the following description, the difference between the microwave heating apparatus 1 of the first embodiment and the microwave heating apparatus 1A of the second embodiment will be mainly described. In FIGS. 8 and 9, like reference numerals will refer to like parts that are the same as those used in the microwave heating apparatus 1 of the first embodiment, and redundant description thereof will be omitted.

The microwave heating apparatus 1A of the present embodiment includes a processing chamber 2 for accommodating therein a wafer W, a microwave introducing unit 3 for introducing a microwave into the processing chamber 2, a support unit 4A for supporting the wafer W in the processing chamber 2, a gas supply mechanism 5 for supplying a gas into the processing chamber 2, a gas exhaust unit 6 for vacuum-exhausting the inside of the processing chamber 2, and a control unit 8 for controlling the respective components of the microwave heating apparatus 1A.

The support unit 4A includes a shaft 14A having a double structure which extends to the outside of the processing chamber 2 through the substantially center of the bottom portion 13 of the processing chamber 2, a dielectric plate 15A as a heating assist member horizontally provided near the upper end of the shaft 14A in an approximately horizontal direction, a plurality of arms 15B installed at the shaft 14A, and a plurality of support pins 16 detachably attached to the arms 15B. The support unit 4A has a rotation driving unit 17 for rotating the shaft 14A, an elevation driving unit 18A for vertically displacing the shaft 14A, and a movable connection unit 19 for connecting the rotation driving unit 17 and the elevation driving unit 18A while supporting the shaft 14A.

The shaft 14A with a double structure has an inner shaft and an outer case (both not shown). The dielectric plate 15A is attached to the inner shaft, and the arms 15B are attached to the outer case.

The inner shaft and the outer case are vertically displaced individually by the elevation driving unit 18A, thereby variably controlling distances between the dielectric plate 15A, the arms 15B and the bottom portion 13.

The number of arms 15B is identical to that of the support pins (e.g., three). Each of the arms 15B extends horizontally radially manner about the shaft 14A. The support pins 16 are attached near the leading ends of the arms 15B. In the present embodiment, the wafer W and the dielectric plate 15A each have a circular plate shape, and the diameter of the dielectric plate 15A is smaller than that of the wafer W.

Therefore, the support pins 16 stand upward from the space below the dielectric plate 15A and support the wafer W at the outer side of the dielectric plate 15A.

The dielectric plate 15A is disposed between the wafer W and the bottom portion 13 below the wafer W while being separated from both of the wafer W and the bottom portion 13 of the processing chamber 2. The dielectric plate 15A functions as the heating assist unit for facilitating the heating of the wafer W. The dielectric plate 15A has the same heating assist function as that of the dielectric plate 15 of the first embodiment. However, the dielectric plate 15A is different from the dielectric plate 15 of the first embodiment in that the support pins 16 for supporting the wafer W are not installed. In the present embodiment, the dielectric plate 15A serving as a heating assist member and the arms 15B for supporting the support pins 16 are formed as separate members.

In the support unit 4A, the shaft 14A, the elevation driving unit 18A and the movable connection unit 19 constitute a displacement mechanism for variably controlling a distance between the dielectric plate 15A and the wafer W supported by the support pins 16. The support pins 16 and the dielectric plate 15A are configured to be vertically displaced individually by driving the elevation driving unit 18A.

The thickness T of the dielectric plate 15A, the height H1 from the top surface of the bottom portion 13 to the bottom surface of the dielectric plate 15A, the height H2 from the top surface of the dielectric plate 15A to the bottom surface of the wafer W, and the height H from the top surface of the bottom portion 13 to the bottom surface of the wafer W of the present embodiment can be set as in the first embodiment. In the present embodiment, particularly in a process of increasing a temperature to about 400° C., the height H1 from the top surface of the bottom portion 13 to the bottom surface of the dielectric plate 15A may be set within a range from, e.g., about 3 mm to 40 mm, and preferably within a range from about 30 mm to 40 mm. Further, it is preferable to set the height H1 at a temperature range higher than about 400° C., to be shorter than the height H1 at a temperature range lower than about 400° C.

(Operation of the Second Embodiment)

Hereinafter, the operation effect of the microwave heating apparatus 1A of the present embodiment will be described.

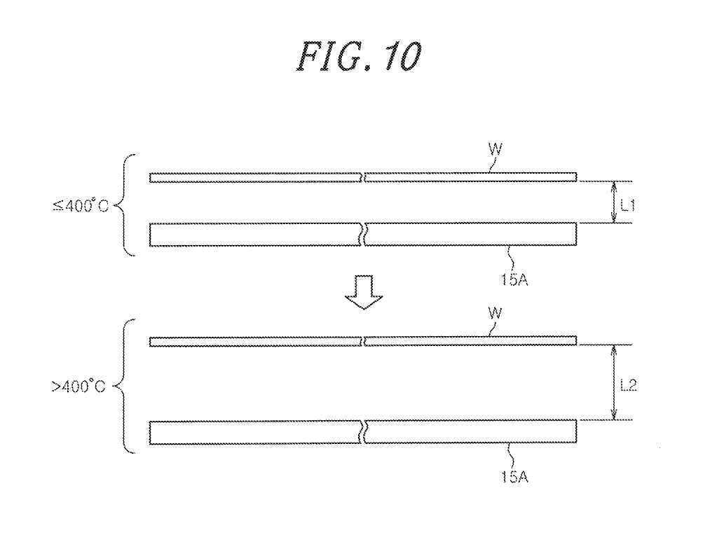

In the microwave heating apparatus 1A of the present embodiment, the heights of the wafer W and the dielectric plate 15A can be individually controlled. FIG. 10 is a principal view for explaining an operation of the microwave heating apparatus 1A of the present embodiment. As shown in FIG. 10, in a process of increasing a temperature up to, e.g., about 400° C., the gap L1 (equal to the height H2) between the wafer W and the dielectric plate 15A is reduced, so that the dielectric plate 15A can effectively generate heat by absorbing a microwave and assist heating of the wafer W. Further, in a process of increasing a temperature to a level higher than about 400° C., the gap L2 (equal to the height H2) between the wafer W and the dielectric plate 15A is increased (i.e., L1<L2), so that the loss (absorption) of the microwave by the dielectric plate 15A itself can be suppressed. Accordingly, the microwave heating apparatus 1A of the present embodiment enables improvement of the heating efficiency of the wafer W, increase of the heating rate and improvement of the throughput of the annealing process. Moreover, the power of the microwave can be effectively supplied to the wafer W. In the present embodiment, the dielectric plate 15A preferably has a heating assist function, and a material of the dielectric plate 15A is not particularly limited. However, in order to obtain an excellent heating assist effect, it is preferable to a dielectric material having a peak of a dielectric rate or a dielectric loss in a temperature range lower than or equal to, e.g., about 400, and whose microwave absorption rate is decreased and reflectivity is relatively increased as a temperature is increased as in the first embodiment.

The other configurations and effects of the microwave heating apparatus 1A of the present embodiment are the same as those of the microwave heating apparatus 1 of the first embodiment. Further, a mechanism for individually displacing the heights of the wafer W and the dielectric plate 15A is not particularly limited. For example, the dielectric plate 15A, the arms 15B and the support pins 16 may be rotated and raised by the respective driving units. In that case, the dielectric plate 15A may be provided as a separate member, not the component of the support unit 4A. In the present embodiment, the dielectric plate 15A may not be rotated.

### Test Example

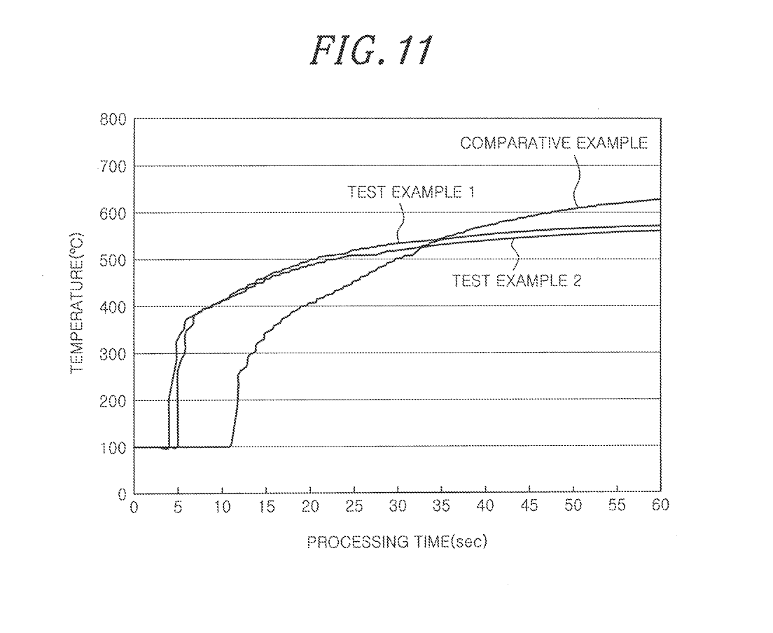

The test result that has become the base of the present invention will be described with reference to FIGS. 11 to 13. In the microwave heating apparatus 1 having the same configuration as that of the first embodiment (see FIGS. 1 to 6), an SiC plate having a diameter of 314 mm and a thickness of 4 mm as a heating assist member was installed such that the height from the top surface of the bottom portion 13 to the bottom surface of the SiC plate was 36 mm and the height from the top surface of the bottom portion 13 to the bottom surface of the wafer W was 53 mm. The gap between the bottom surface of the wafer W and the top surface of the SiC plate was 13 mm.

As for the wafer W, a silicon wafer having a diameter of 300 mm was used. As for the SiC plate, a sample A (volume resistivity of 4×10⁴ Ω·cm) and a sample B (volume resistivity of 6×10⁶ Ω·cm) were used in the first test example and the second test example, respectively.

The measurement result of the heating rate of the wafer W was shown in FIG. 11. The case where a SiC plate was not provided was tested as a comparative example. It is clear from FIG. 11 that the heating rate up to about 400° C. is more than twice greater in the test examples 1 and 2 using the SiC plate than that in the comparative example, which shows the heating assist effect by the SiC plate.

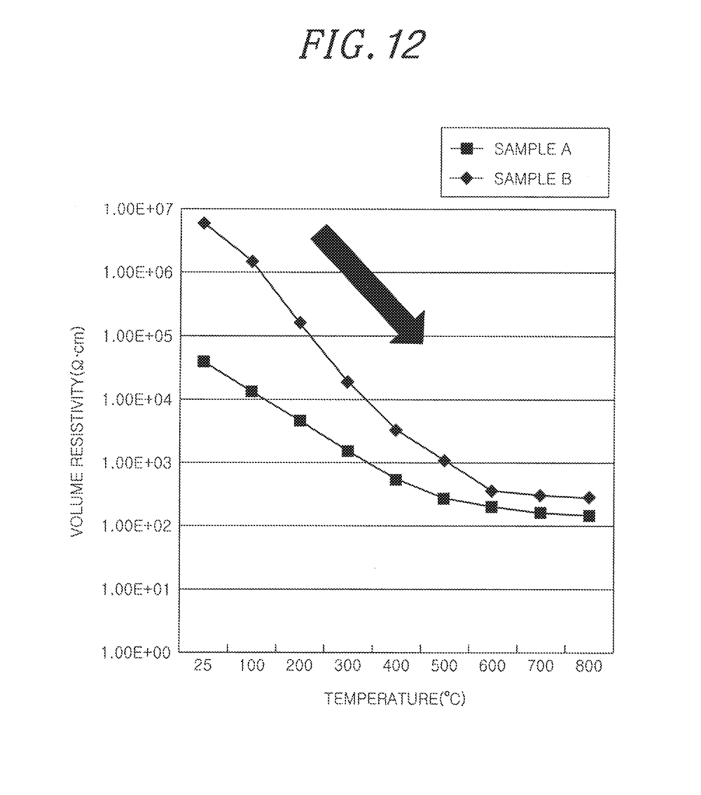

Next, the result of measuring temperature variation of volume resistivity in the SiC plates of the samples A and B is shown in FIG. 12. It is clear from FIG. 12 that the volume resistivity is decreased as the temperature is increased, which shows that the dielectric properties of the SiC plates of the samples A and B become relatively close to conductive properties.

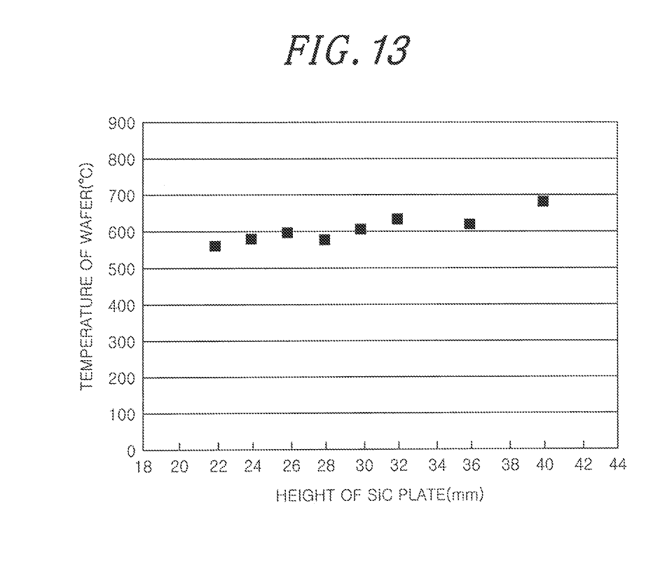

Next, a result of a test for examining effects to the heating temperature (highest attainable temperature) of the wafer W in the case of varying the height of the SiC plate by using the sample A was shown in FIG. 13. In this test, the height from the top surface of the bottom portion 13 to the bottom surface of the SiC plate was set within the range from 22 mm to 40 mm. The gap between the bottom surface of the wafer W and the top surface of the SiC plate was uniformly set to 13 mm. It is seen from FIG. 13 that the highest attainable temperature of the wafer W in the annealing process can be changed by varying the height from the top surface of the bottom portion 13 to the bottom surface of the SiC plate.

The present invention may be variously modified without being limited to the above embodiments. For example, the microwave heating apparatus of the present invention is not limited to the case of using a semiconductor wafer as an object to be processed, and may also be applied to a microwave heating apparatus using as an object to be processed, e.g., a substrate for a solar cell panel or a substrate for a flat panel display.

In the above embodiment, the dielectric plates 15 and 15A serving as the heating assist member are disposed below the wafer W. However, it may be deposed, e.g., above the wafer W.

In the above embodiments, the dielectric plates 15 and 15A serving as the heating assist member are components of the support units 4 and 4A. However, the dielectric plate 15 may not be a component of the support unit.

The number of the microwave units 30 (the number of the magnetrons 31) or the number of the microwave inlet ports 10 in the microwave heating apparatus is not limited to that described in the above embodiments.

While the invention has been shown and described with respect to the embodiments, it will be understood by those skilled in the art that various changes and modification may be made without departing from the scope of the invention as defined in the following claims.

What is claimed is:

1. A microwave heating apparatus comprising:
a processing chamber configured to accommodate an object to be processed, the processing chamber having a top wall, a bottom wall and a sidewall;
a microwave introducing unit configured to generate a microwave for heating the object and introduce the microwave into the processing chamber;
a support member configured to support the object by contact with the object in the processing chamber; and
a heating assist member configured to generate heat by absorbing the microwave and assist heating of the object by radiant heat, the heating assist member disposed to be separated from the object by the support member.

2. The microwave heating apparatus of claim 1, wherein the object and the heating assist member each have a plate shape, and main surfaces thereof with largest areas are disposed to face each other at least partially.

3. The microwave heating apparatus of claim 1, wherein the heating assist member is made of a dielectric material.

4. The microwave heating apparatus of claim 3, wherein the dielectric material includes one or more selected from a group consisting of SiC, SiN, Al₂O₃ and AlN.

5. The microwave heating apparatus of claim 1, wherein the heating assist member is made of a dielectric material whose microwave absorption rate is decreased and whose reflectivity is increased, as a temperature is increased in a process of increasing a temperature of the object.

6. The microwave heating apparatus of claim 1, further comprising a height control unit configured to variably control a height from the bottom wall to the heating assist member.

7. The microwave heating apparatus of claim 1, further comprising a displacement unit configured to variably control a distance between the heating assist member and the object.

8. The microwave heating apparatus of claim 1, further comprising a rotation unit configured to rotate the supporting members in a horizontal direction.

9. The microwave heating apparatus of claim 1, wherein the upper wall of the processing chamber has a plurality of microwave inlet ports for introducing the microwave generated by the microwave introducing unit into the processing chamber

10. A processing method for heating an object to be processed by using a microwave heating apparatus including:
a processing chamber configured to accommodate therein the object, the processing chamber having an upper wall, a bottom wall, and a sidewall;
a microwave introducing unit configured to generate a microwave for heating the object and introduce the microwave into the processing chamber;
a plurality of supporting members configured to support the object by contact with the object in the processing chamber; and
a heating assist member configured to generate heat by absorbing the microwave and assist heating of the object by radiant heat, the heating assist member disposed to be separated from the object supported by the supporting members.

11. The processing method of claim 10, wherein the object supported by the supporting member is heated while being rotated.
